(19) United States
(12) Patent Application Publication
(10) Pub. No.: US 2014/0026931 A1
(43) Pub. Date: Jan. 30, 2014

(54) PIVOT MECHANISM AND TENT FRAME USING SAME

(71) Applicant: YU CHIEH LEE, TAINAN (TW)

(72) Inventor: YU CHIEH LEE, TAINAN (TW)

(21) Appl. No.: 13/558,919

(22) Filed: Jul. 26, 2012

(51) Int. Cl. E05D 7/00; E04H 15/48

(52) U.S. Cl. 135/144; 16/382

(57) ABSTRACT

A pivot mechanism and a tent frame using same are disclosed. The pivot mechanism includes a first unit having two spaced mounting brackets formed with a pivot hole each; and a second unit including a main body, two protruded shafts movably connected to two opposite side surfaces of the main body, and an elastic member connected to the protruded shafts. The protruded shafts can shift between a compressed position, in which a smallest distance between two protruded end surfaces of the protruded shafts is not larger than a distance between two facing sides of the mounting brackets, and a sprung-out position, in which the two protruded shafts are protruded from the side surfaces of the main body into the pivot holes on the mounting brackets. When the second unit is pushed to a proper position between the two mounting brackets, the protruded shafts will automatically extend into the pivot holes.

### FIELD OF THE INVENTION

The present invention relates to a pivot mechanism and a tent frame using such pivot mechanism.

### BACKGROUND OF THE INVENTION

Pivot mechanisms are very often used on various folding furniture and foldable camping gear products, such as tent frames, beach chairs, folding bed frames and the like. A currently available pivot mechanism generally includes a first unit, a second unit and a bolt. The first unit includes two spaced mounting brackets, and the second unit is clamped between the two mounting brackets. The bolt is extended through the two mounting brackets, the second unit and necessary washers to engage with a nut, so as to lock the second unit to the first unit while allowing the first and the second unit to pivotally turn relative to each other. The above-described pivot mechanism requires at least two steps to assemble the first and the second unit to each other. First, set and clamp the second unit between the two mounting brackets; and then extend the bolt through the two units and washers to engage with the nut. Therefore, it is troublesome and time-consuming to assemble the conventional pivot mechanism.

### SUMMARY OF THE INVENTION

A primary object of the present invention is to provide an improved pivot mechanism and a tent frame using same to overcome the drawbacks in the prior art pivot mechanism, such as the troublesome and time-consuming assembling thereof.

To achieve the above and other objects, the pivot mechanism according to a first embodiment of the present invention includes a first unit having two spaced mounting brackets with two pivot holes formed on their facing sides; and a second unit including a main body connected to between the two mounting brackets, two protruded shafts separately protruded from two opposite side surfaces of the main body, and an elastic member connected to the protruded shafts to provide an elastic force for the two protruded shafts to spring out. The protruded shafts are movably connected to the main body to shift between a compressed position and a sprung-out position. While in the compressed position, a smallest distance between two protruded end surfaces of the two protruded shafts is not larger than a distance between the two facing sides of the mounting brackets; and while in the sprung-out position, the two protruded shafts are protruded from the side surfaces of the main body into the pivot holes on the mounting brackets.

According to a preferred embodiment, the elastic member includes two suspended plates separately connected to the two protruded shafts; and each of the suspended plates has an immovable end fixedly connected to the main body and a movable end connected to one corresponding protruded shaft.

According to a preferred embodiment, the main body includes a pipe and a connection base, and the suspended plates are connected to the connection base.

According to a preferred embodiment, the connection base includes a connection head fixedly connected to an end of the pipe and two spaced connection plates symmetrically fixedly connected to the connection head. The connection plates are respectively provided with a through hole, and the suspended plates are located within the through holes with their immovable ends fixedly connected to an inner edge of the through holes.

According to a preferred embodiment, the pipe is a hollow pipe defining an inner space therein, and the connection head and the connection plates have an insertion space formed between them. The connection head is inserted into the inner space of the pipe, the connection plates are located outside the pipe, and the insertion space encloses side surfaces at the end of the pipe therein.

According to a preferred embodiment, the main body is a hollow pipe and is provided on two opposite side surfaces thereof with a through hole each, and each of the protruded shafts has a stopper fixedly connected to an inner end surface thereof. The protruded shafts respectively have a cross section smaller than that of the through holes on the hollow pipe while the stoppers respectively have a cross section larger than that of the through holes on the hollow pipe. The elastic member is fitted in the hollow pipe with two ends pressing against the two stoppers, so that the two stoppers are rest on two opposite inner side surfaces of the hollow pipe under the action of the elastic member and the two protruded shafts are outward extended through the through holes on the hollow pipe.

According to a preferred embodiment, the main body is a hollow pipe and is provided on two opposite side surfaces thereof with a through hole each, and the elastic member is a V-shaped elastic member fitted inside the hollow pipe. The two protruded shafts are separately fixedly connected to two terminal ends of the V-shaped elastic member, so that the two protruded shafts are biased by the elastic member to outward extend through the through holes on the hollow pipe.

According to a preferred embodiment, a distance between the two opposite side surfaces of the hollow pipe matches a distance between the two facing sides of the mounting brackets.

According to a preferred embodiment, the first unit includes a pipe, and the two mounting brackets are directly welded to the pipe of the first unit.

According to a preferred embodiment, the first unit includes a pipe and a fixed joint mounted to an upper end thereof, and the two mounting brackets are provided on the fixed joint.

To achieve the above and other objects, the pivot mechanism according to a second embodiment of the present invention includes a first unit and a second unit. The first unit has two spaced mounting brackets, two protruded shafts located face to face and capable of separately protruding from the two mounting brackets, and an elastic member connected to the protruded shafts and capable of providing an elastic force for the two protruded shafts to spring out. The protruded shafts are movably connected to the two mounting bracket to shift between a compressed position and a sprung-out position. The second unit includes a main body connected to between the two mounting brackets and provided on two opposite side surfaces with a pivot hole each. When the protruded shafts are in the compressed position, a distance between two protruded end surfaces of the protruded shafts is not smaller than a distance between the two opposite side surfaces of the main body, and when the protruded shafts are in the sprung-out position, they are protruded from two facing sides of the mounting brackets into the pivot holes on the main body.

According to a preferred embodiment, the mounting brackets are respectively provided with a through hole, and the elastic member includes two suspended plates separately connected to the two protruded shafts. Each of the suspended plates has an immovable end fixedly connected to an inner edge of the through hole on the corresponding mounting bracket, and a movable end fixedly connected to the corresponding protruded shaft. Further, the suspended plates are located within the through holes on the mounting brackets.

According to a preferred embodiment, the protruded shafts respectively have a bevel surface formed on a front end surface, a lower end surface or an upper end surface thereof to serve as a guide face.

To achieve the above and other objects, the tent frame using the pivot mechanism according to the present invention includes a plurality of poles and a side strut connected to between any two adjacent ones of the poles. The side strut each is formed from multiple scissor linkages, and each of the poles has a slidable joint movably fitted thereon. Two outmost upper ends of each side strut are connected to an upper end of one corresponding pole via one pivot mechanism, and two outmost lower ends of each side strut are connected to the slidable joint on one corresponding pole via another pivot mechanism. At least one of the two pivot mechanisms includes a first unit and a second unit.

The first unit includes two spaced mounting brackets, which are provided on their facing sides with a pivot hole each.

The second unit includes a main body connected to between the two mounting brackets, two protruded shafts separately protruded from two opposite side surfaces of the main body facing away from each other, and an elastic member connected to the protruded shafts and being capable of providing an elastic force for the two protruded shafts to spring out. The protruded shafts are movably connected to the main body to shift between a compressed position and a sprung-out position. When the protruded shafts are in the compressed position, a smallest distance between two protruded end surfaces of the two protruded shafts is not larger than a distance between the two facing sides of the mounting brackets, and when the protruded shafts are in the sprung-out position, they are protruded from the side surfaces of the main body into the pivot holes on the mounting brackets.

Compared to the prior art, the pivot mechanism according to the present invention is characterized in that the protruded shafts are connected to the main body via the elastic member and accordingly automatically biased by the elastic member into the pivot holes when the second unit is pushed into a proper position between the two mounting brackets. Therefore, the present invention overcomes the drawbacks in the prior art and has the following advantages: (1) it requires only one step to complete the assembly thereof and therefore largely reduces the time and labor for assembling to also reduce the overall product cost; (2) due to the convenient assembling, the product can be delivered with the first and the second unit in a disassembled state and users can assemble the product by themselves, and the product in the disassembled state occupies only small space in the furniture shop before it is sold to a user and can therefore be more easily packed, transported and stored; (3) in the case the elastic member includes two suspended plates, the suspended plates are movably connected to between the main body and the protruded shafts, so that the protruded shafts, the elastic member and the connection base can be integrally formed to save the material and reduce the fabrication cost; further, since the suspended plates are located within two through holes, the connection base not only provides sufficient moving space for the suspended plates to move, but also enables the suspended plates to have increased coefficient of elasticity; (5) in the case the elastic member is a compression elastic member or a V-shaped elastic member connected at two ends to the two protruded shafts, the protruded shafts can be biased by the elastic member to extend through the through holes on the main body into the pivot holes on the mounting brackets; since the protruded shafts are located in the through holes, they can be more firmly and stably engaged with the pivot holes; (6) since the two mounting brackets can be directly welded to the pipe, the fixed joint can be saved to reduce the manufacturing cost; (7) since the protruded shafts can be provided on the mounting brackets, the manufacturing can be simplified; and since the pivot holes can be provided on the second unit, the suspended plates can be located within the through holes provided on the mounting brackets; and (8) the protruded shafts respectively have a bevel surface formed on a front end surface, a lower end surface or an upper end surface thereof to serve as a guide face, and the force driving the second unit into the first unit can be resolved by the guide face into a push component force for keeping driving the second unit forward and a pushing force for compressing the elastic member and allowing the same to store elastic energy, so that the pivot mechanism can be more conveniently assembled.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a tent frame using a pivot mechanism according to the present invention;

FIG. 2 is an enlarged assembled perspective view of the circled area A of FIG. 1, showing the pivot mechanism of the present invention according to a first preferred embodiment thereof;

FIG. 3 is an enlarged exploded perspective view of the circled area A of FIG. 1 in an upside-down position;

FIG. 4 is an enlarged assembled cross-sectional view of the circled area A of FIG. 1;

FIG. 5 is an enlarged exploded cross-sectional view of the circled area of A of FIG. 1;

FIG. 6 is a sectional view taken along line C-C of FIG. 4;

FIG. 7 is an enlarged assembled perspective view of the circled area B of FIG. 1;

FIG. 8 is an enlarged exploded perspective view of the circled area B of FIG. 1 in an upside-down position;

FIG. 9 is an exploded cross-sectional view showing the pivot mechanism of the present invention according to a second preferred embodiment thereof;

FIG. 10 is an exploded cross-sectional view showing the pivot mechanism of the present invention according to a third preferred embodiment thereof;

FIG. 11 is an exploded cross-sectional view showing the pivot mechanism of the present invention according to a fourth preferred embodiment thereof; and

FIG. 12 is a perspective view of another tent frame using the pivot mechanism of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

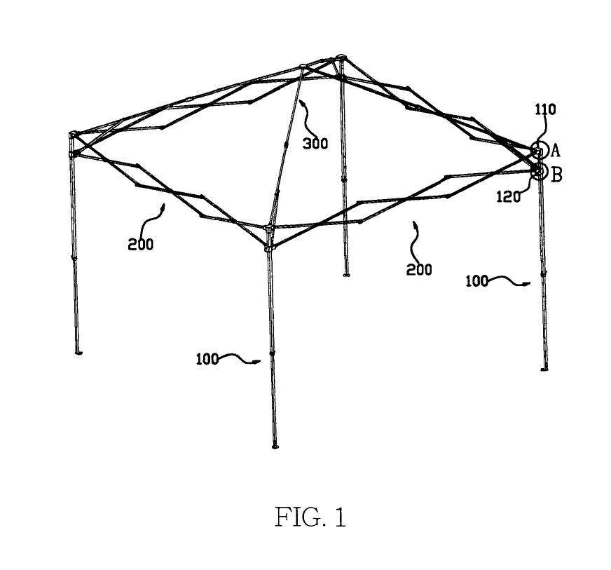

Please refer to FIG. 1, in which a tent frame using a pivot mechanism of the present invention is shown. The tent frame includes four poles 100, four side struts 200, and a canopy frame 300. Each of the poles 100 has a fixed joint 110 mounted to an upper end thereof, and a slidable joint 120 movably fitted thereon below the fixed joint 110. Each of the side struts 200 is formed from three serially pivotally connected scissor linkages, and therefore has two outmost upper ends and two outmost lower ends. The two outmost upper ends are separately pivotally connected to the fixed joints 110 on two adjacent poles 100, and the two outmost lower ends are separately pivotally connected to the slidable joints 120 on the two adjacent poles 100. The canopy frame 300 includes a hub and four top struts. Each of the top struts includes two strut rods pivotally connected end to end and a stretcher. All the top struts have their first strut rods pivotally connected at respective first end to the hub and at respective second end to a first end of one corresponding second strut rod; and the second strut rods are pivotally connected at respective second end to the fixed joint 110 on one corresponding pole 100. The stretchers respectively have an upper end pivotally connected to a middle portion of one corresponding second strut rod and a lower end pivotally connected to the slidable joint 120 on one corresponding pole 100.

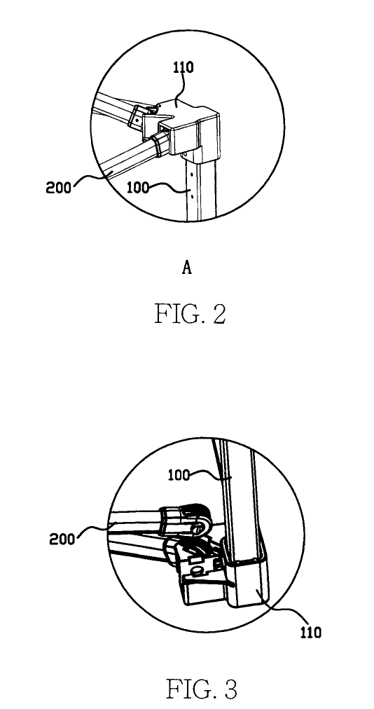

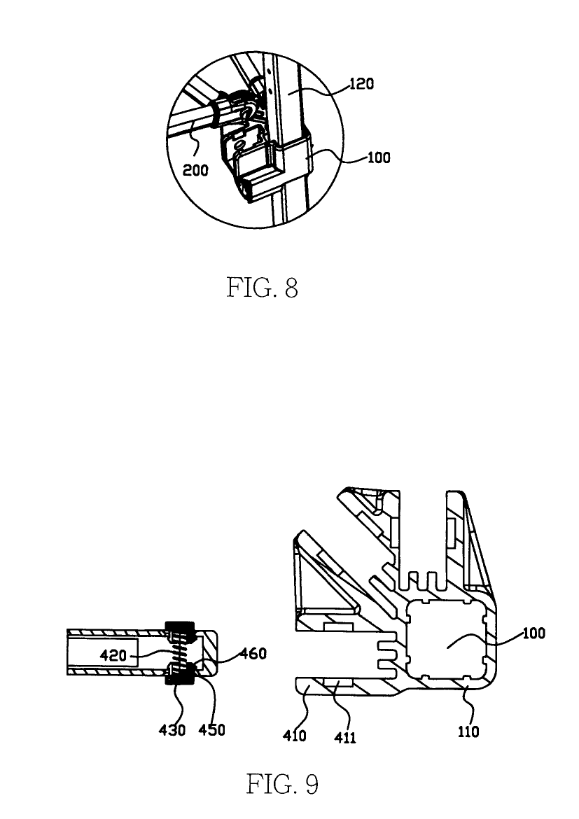

Each fixed joint 110 is connected to the outmost upper ends of two adjacent side struts 200 and the second strut rod of one corresponding top strut of the canopy frame 300 via one pivot mechanism of the present invention, as shown in FIGS. 2 and 3. Similarly, each slidable joint 120 is connected to the outmost lower ends of two adjacent side struts 200 and the stretcher of one corresponding top strut of the canopy frame 300 via another pivot mechanism of the present invention, as shown in FIGS. 7 and 8. Since the pivot mechanisms provided at all the fixed joints 110 and the slidable joints 120 are same, the present invention is described herein based on only the pivot mechanism provided between the fixed joint 110 and the outmost upper end of one side strut 200.

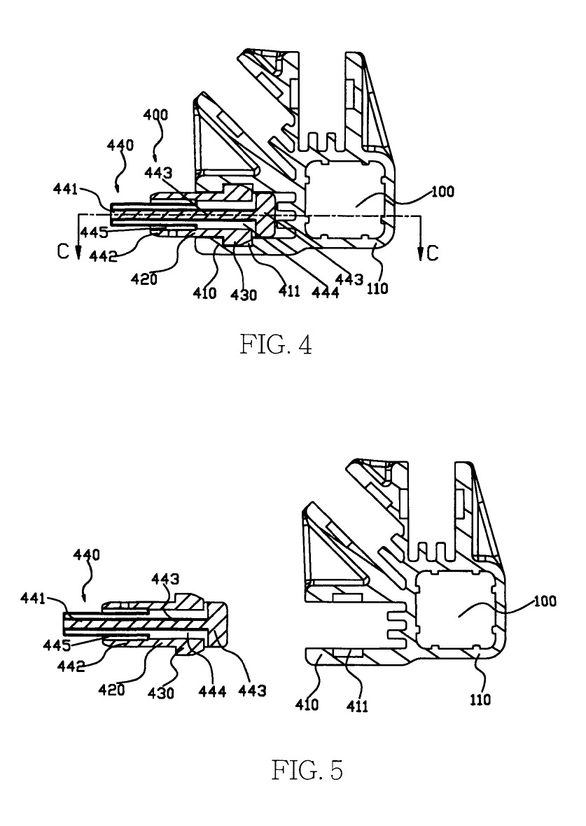

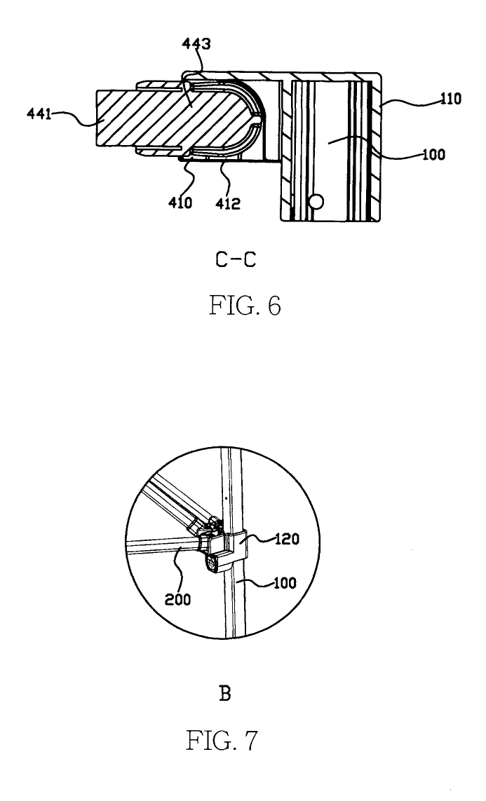

Please refer to FIGS. 2 to 6, in which the pivot mechanism of the present invention according to a first preferred embodiment thereof is shown, and is generally denoted by reference numeral 400. As shown, the pivot mechanism 400 includes a first unit and a second unit pivotally turnably connected to each other.

The first unit includes a first pipe and a fixed joint immovably mounted on the first pipe. In the illustrated first preferred embodiment, the first pipe is the above-mentioned pole 100, and the fixed joint is the above-mentioned fixed joint 110. The fixed joint 110 includes two parallel and laterally spaced mounting brackets 410. The two mounting brackets 410 are provided on their facing sides with a pivot hole 411 each. The two pivot holes 411 are coaxial and identical in structure. Depending on actual need, the pivot holes 411 can be through holes or blind holes. To facilitate convenient mounting or assembling, the mounting brackets 410 are also provided with a guide rail 412 each. The guide rails 412 have sloping surfaces or curved surfaces.

The second unit includes a main body, an elastic member 420, and two protruded shafts 430 matching the two pivot holes 411. The main body includes a hollow second pipe and a connection base 440. The protruded shafts 430 respectively have a chamfered end. In the illustrated first preferred embodiment, the second pipe is one of two pivotally connected link pipes forming an outer one of the three scissor linkages of the above-mentioned side strut 200.

The connection base 440 includes a connection head 441 and two laterally spaced connection plates 442 symmetrically fixedly connected to two lateral outer sides of the connection head 441. The connection plates 442 are connected to the connection head 441 in such a manner that a rear-opened insertion space 445 is formed between the connection head 441 and the connection plates 442. The connection head 411 is fixedly inserted into a hollow space defined in the second pipe with the connection plates 442 being located outside the second pipe and the insertion space 445 enclosing outer surfaces of the second pipe. In this manner, it is able to control a depth by which the connection head 441 is inserted into the second pipe to ensure sufficient connection strength. To give the connection base 440 with increased strength, a central plate 443 is provided to fixedly connect at an end to the connection head 441 and at another opposite end to front ends of the connection plates 442. To give the whole connection base 440 an esthetic appearance, cover plates are fixedly connected to between the connection plates 442. The connection plates 442 are formed with a through hole 444 each.

The elastic member 420 includes two suspended plates, each of which has an immovable end fixedly connected to an inner edge of one corresponding through hole 444 and a movable end connected to one corresponding protruded shaft 430. Since the protruded shafts 430 are respectively fixedly connected to the movable ends of the suspended plates, and since the suspended plates are connected at their immovable ends to the inner edge of the through holes 444, the two protruded shafts 430 are actually separately connected to two facing away sides (i.e. right and left outer sides) of the connection base 440 (i.e. the main body). Moreover, since the suspended plates respectively have a movable end in a suspended state, and since the protruded shafts 430 are respectively fixedly connected to the movable (i.e. suspended) ends of the suspended plates, the suspended plates are able to provide the protruded shafts 430 with a spring force to spring out. Further, since the protruded shafts 430 are indirectly connected to the connection base 440 via the suspended plates, the protruded shafts 430 are movable relative to the connection base 440 (i.e. the main body) to shift between a compressed position and a sprung-out position. In the compressed position, a smallest distance between two protruded end surfaces of the two protruded shafts 430 is not larger than a distance between the facing sides of the two mounting brackets 410. On the other hand, in the sprung-out position, the protruded shafts 430 will protrude from the lateral surfaces of the connection base 440 (i.e. the main body) under the spring force of the suspended plates to thereby insert into the pivot holes 411 formed on the mounting brackets 410. Preferably, while in the sprung-out position, the centerlines of the protruded shafts 430 are perpendicular to the two lateral surfaces of the main body and aligned with the axes of the pivot holes 411. Therefore, an angle contained between the centerline of each protruded shaft and the immovable end of the suspended plate is equal to a sum of 90° and an angle contained between the suspended plate at the sprung-out position and the lateral surface of the main body. Preferably, while in the sprung-out position, the suspended plates still possess a certain degree of spring-out force to firmly push the protruded shafts into the pivot holes.

Please refer to FIGS. 3 and 5. To connect or assemble the second unit to the first unit, first align the second unit with a space defined by between the two mounting brackets 410 of the first unit and then drive the second unit forward. When the protruded shafts 430 contact with the guide rails 412 of the mounting brackets 410, the driving force is resolved by the guide rails 412 into a pushing force, which pushes the protruded shafts 430 for the same to retract so that the elastic member 420 stores an elastic energy, and a push component force, which keeps driving the second unit forward. When the two protruded shafts 430 are compressed to an extent that the distance between the two protruded end surfaces of the two protruded shafts 430 is equal to the distance between the two facing sides of the two mounting brackets 410, the protruded shafts 430 can be freely moved between the two mounting brackets 410. At this point, the driving force is not resolved. And when the protruded shafts 430 are moved to a position corresponding to the pivot holes 411, the elastic member 420 releases the stored elastic energy and the protruded shafts 430 are pushed to protrude from the lateral surfaces of the connection base 440 (i.e. the main body) into the pivot holes 411 on the mounting brackets 410.

While the pivot mechanism 400 of the present invention has been described with an embodiment in connection with a tent frame, it is understood the pivot mechanism of the present invention can also be applied to other articles, such as the frames for a beach chair, a folding bed and the like.

Please refer to FIG. 9 that is an exploded cross-sectional view showing a second preferred embodiment of the pivot mechanism of the present invention somewhat different from the first embodiment.

In the second preferred embodiment, the second unit includes a main body, an elastic member 420, and two protruded shafts 430 matching the pivot holes 411. The main body includes a second pipe, and the protruded shafts 430 respectively have a chamfered protruded end. In the illustrated second preferred embodiment, the second pipe is one of two pivotally connected link pipes forming an outer one of the three scissor linkages of the above-mentioned side strut 200.

The second pipe is a hollow pipe, and is so dimensioned that a distance between two opposite outer side surfaces thereof matches a distance between two facing sides of the two mounting brackets. The two opposite lateral side surfaces of the hollow pipe are respectively provided with a through hole 450. Each of the protruded shafts 430 has a stopper 460 fixedly connected to an inner end surface thereof. The protruded shafts 430 respectively have a cross section smaller than that of the through holes 450, while the stoppers 460 respectively have a cross section larger than that of the through holes 450. The elastic member is a compression spring fitted in the hollow pipe with two ends of the spring pressing against the two stoppers 460, so that the two stoppers 460 are rest on two opposite inner side surfaces of the hollow pipe under the action of the elastic member 420 and the two protruded shafts 430 are outward extended through the through holes 450 into the pivot holes 411 on the mounting brackets 410. With the above structure, it is able to ensure the alignment of the centerlines of the protruded shafts 430 with the axes of the pivot holes 411.

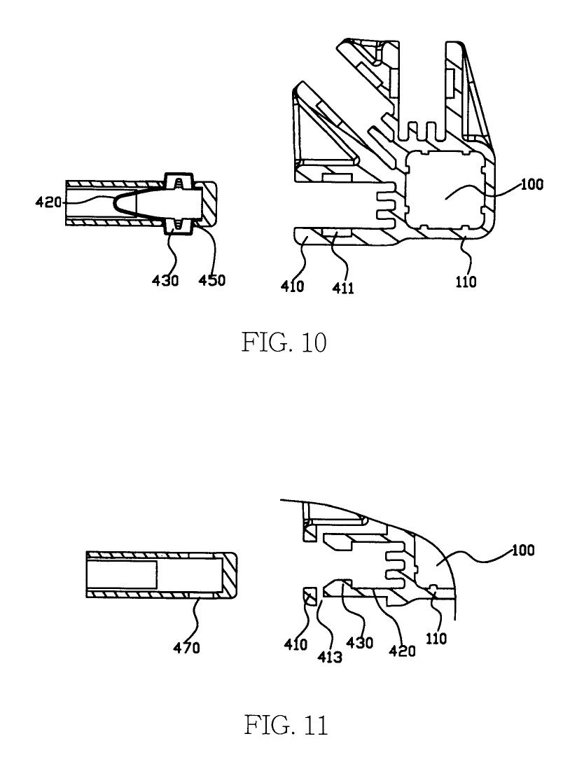

Please refer to FIG. 10 that is an exploded cross-sectional view showing a third preferred embodiment of the pivot mechanism of the present invention somewhat different from the first embodiment.

In the third preferred embodiment, the second unit includes a main body, an elastic member 420, and two protruded shafts 430 matching the pivot holes 411. The main body includes a second pipe, and the protruded shafts 430 respectively have a chamfered end. In the illustrated third preferred embodiment, the second pipe is one of two pivotally connected link pipes forming an outer one of the three scissor linkages of the above-mentioned side strut 200.

The second pipe is a hollow pipe, and is so dimensioned that a distance between two opposite outer side surfaces thereof matches a distance between two facing sides of the two mounting brackets. The two opposite lateral side surfaces of the hollow pipe are respectively provided with a through hole 450. The elastic member 420 is a substantially V-shaped elastic member fitted inside the hollow pipe. The two protruded shafts 430 are fixedly connected to two terminal ends of the V-shaped elastic member. Under the action of the elastic member 420, the two protruded shafts 430 are outward extended through the through holes 450 into the pivot holes 411 on the mounting brackets 410.

Please refer to FIG. 11 that is an exploded cross-sectional view showing a fourth preferred embodiment of the pivot mechanism of the present invention somewhat different from the first embodiment.

In the fourth preferred embodiment, the first unit includes a first pipe and a fixed joint immovably mounted on the first pipe. In the illustrated fourth preferred embodiment, the first pipe is the above-mentioned pole 100, and the fixed joint is the above-mentioned fixed joint 110. The fixed joint 110 includes two parallel and laterally spaced mounting brackets 410, two protruded shafts 430 separately connected to the two mounting brackets 410 to face toward each other, and an elastic member 420. The mounting brackets 410 are respectively provided with a through hole 413. The elastic member 420 includes two suspended plates, each of which has an immovable end fixedly connected to an inner edge of one corresponding through hole 413 and a movable end connected to one corresponding protruded shaft 430.

The second unit includes a main body, which includes a second pipe. In the illustrated fourth preferred embodiment, the second pipe is one of two pivotally connected link pipes forming an outer one of the three scissor linkages of the above-mentioned side strut 200. The main body is provided on two opposite outer side surfaces, which face away from each other, with a pivot hole 470 each. Depending on actual need, it is also possible to directly provide a through hole that extends through two opposite side surfaces of the second pipe, so that two ends of the through hole form two pivot holes on the second pipe. While in the compressed position, a distance between two protruded end surfaces of the two protruded shafts 430 is not smaller than a distance between two opposite outer side surfaces of the main body; and while in the sprung-out position, the two protruded shafts 430 protrude from the two facing sides of the two mounting brackets 410 into the pivot holes 470.

The protruded shafts 430 in the fourth preferred embodiment respectively have a beveled front end to function as a guide face. Therefore, when the second unit is driven forward to mount or assemble to the first unit, a pushing force resolved from the driving force by the beveled front ends of the protruded shafts 430 is able to move the two protruded shafts 430 to the compressed position, allowing the two protruded shafts 430 to spring out into the pivot holes 470 when they are aligned with the pivot holes 470.

According to another embodiment of the pivot mechanism not illustrated in the drawings, the mounting brackets 410 are directly welded to the upper end of the pole 100 to substitute for or save the fixed joint 110.

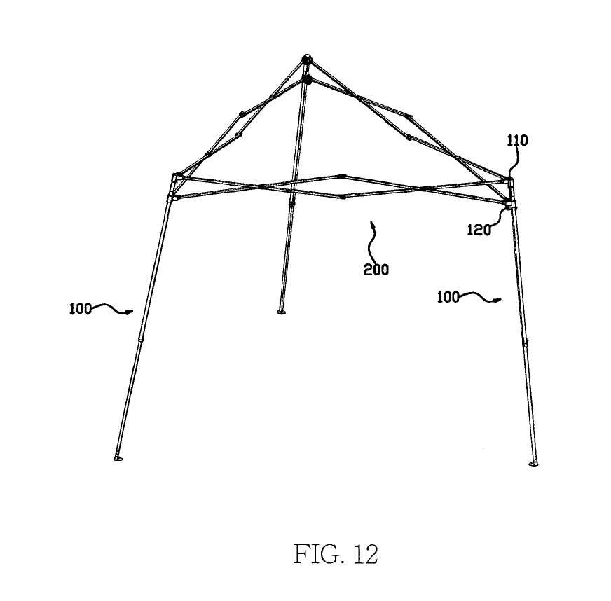

FIG. 12 shows another tent frame using the pivot mechanism of the present invention.

The tent frame in FIG. 12 is different from the tent frame in FIG. 1 in that it includes three poles 100 and three side struts 200. Each of the poles 100 has a fixed joint 110 mounted to an upper end thereof, and a slidable joint 120 movably fitted thereon below the fixed joint 110. Each of the side struts 200 is formed from two serially pivotally connected scissor linkages, and therefore has two outmost upper ends and two outmost lower ends. The two outmost upper ends are separately pivotally connected to the fixed joints 110 on two adjacent poles 100, and the two outmost lower ends are separately pivotally connected to the slidable joints 120 on the two adjacent poles 100.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A pivot mechanism, comprising:
a first unit including two spaced mounting brackets, which are provided on their facing sides with a pivot hole each; and
a second unit including a main body connected to between the two mounting brackets, two protruded shafts separately protruded from two opposite side surfaces of the main body facing away from each other, and an elastic member connected to the protruded shafts and being capable of providing an elastic force for the two protruded shafts to spring out; the protruded shafts being movably connected to the main body to shift between a compressed position and a sprung-out position; wherein when the protruded shafts are in the compressed position, a smallest distance between two protruded end surfaces of the two protruded shafts is not larger than a distance between the two facing sides of the mounting brackets, and when the protruded shafts are in the sprung-out position, they are protruded from the side surfaces of the main body into the pivot holes on the mounting brackets.

2. The pivot mechanism as claimed in claim 1, wherein the elastic member includes two suspended plates separately connected to the two protruded shafts; and each of the suspended plates having an immovable end fixedly connected to the main body and a movable end connected to one corresponding protruded shaft.

3. The pivot mechanism as claimed in claim 2, wherein the main body includes a pipe and a connection base, and the suspended plates being connected to the connection base.

4. The pivot mechanism as claimed in claim 3, wherein the connection base includes a connection head fixedly connected to an end of the pipe and two spaced connection plates symmetrically fixedly connected to the connection head; the connection plates being respectively provided with a through hole, and the suspended plates being located within the through holes with their immovable ends fixedly connected to an inner edge of the through holes.

5. The pivot mechanism as claimed in claim 4, wherein the pipe is a hollow pipe defining an inner space therein, and the connection head and the connection plates have an insertion space formed between them; wherein the connection head is inserted into the inner space of the pipe, the connection plates are located outside the pipe, and the insertion space encloses side surfaces at the end of the pipe.

6. The pivot mechanism as claimed in claim 1, wherein the main body is a hollow pipe and is provided on two opposite side surfaces thereof with a through hole each, and each of the protruded shafts has a stopper fixedly connected to an inner end surface thereof; the protruded shafts respectively having a cross section smaller than that of the through holes on the hollow pipe while the stoppers respectively having a cross section larger than that of the through holes on the hollow pipe; and the elastic member being fitted in the hollow pipe with two ends pressing against the two stoppers, so that the two stoppers are rest on two opposite inner side surfaces of the hollow pipe under the action of the elastic member and the two protruded shafts are outward extended through the through holes on the hollow pipe.

7. The pivot mechanism as claimed in claim 6, wherein a distance between the two opposite side surfaces of the hollow pipe matches a distance between the two facing sides of the mounting brackets.

8. The pivot mechanism as claimed in claim 1, wherein the main body is a hollow pipe and is provided on two opposite side surfaces thereof with a through hole each, and the elastic member is a V-shaped elastic member fitted inside the hollow pipe; and the two protruded shafts being separately fixedly connected to two terminal ends of the V-shaped elastic member, so that the two protruded shafts are biased by the elastic member to outward extend through the through holes on the hollow pipe.

9. The pivot mechanism as claimed in claim 8, wherein a distance between the two opposite side surfaces of the hollow pipe matches a distance between the two facing sides of the mounting brackets.

10. The pivot mechanism as claimed in claim 1, wherein the first unit includes a pipe, and the two mounting brackets being directly welded to the pipe of the first unit.

11. The pivot mechanism as claimed in claim 1, wherein the first unit includes a pipe and a fixed joint mounted to an upper end thereof, and the two mounting brackets being provided on the fixed joint.

12. A pivot mechanism, comprising:
a first unit including two spaced mounting brackets, two protruded shafts located face to face and capable of separately protruding from the two mounting brackets, and an elastic member connected to the protruded shafts and capable of providing an elastic force for the two protruded shafts to spring out; and the protruded shafts being movably connected to the two mounting bracket to shift between a compressed position and a sprung-out position; and
a second unit including a main body connected to between the two mounting brackets; and the main body being provided on two opposite side surfaces with a pivot hole each;
wherein when the protruded shafts are in the compressed position, a distance between two protruded end surfaces of the protruded shafts is not smaller than a distance between the two opposite side surfaces of the main body, and when the protruded shafts are in the sprung-out position, they are protruded from two facing sides of the mounting brackets into the pivot holes on the main body.

13. The pivot mechanism as claimed in claim 12, wherein the mounting brackets are respectively provided with a through hole, and the elastic member includes two suspended plates separately connected to the two protruded shafts; each of the suspended plates having an immovable end fixedly connected to an inner edge of the through hole on the corresponding mounting bracket, and a movable end fixedly connected to the corresponding protruded shaft; and the suspended plates being located within the through holes on the mounting brackets.

14. The pivot mechanism as claimed in claim 12, wherein the protruded shafts respectively have a bevel surface formed on a front end surface, a lower end surface or an upper end surface thereof to serve as a guide face.

15. A tent frame, comprising a plurality of poles and a side strut connected to between any two adjacent ones of the poles; the side strut each being formed from multiple scissor linkages, and each of the poles having a slidable joint movably fitted thereon; two outmost upper ends of each side strut being connected to an upper end of one corresponding pole via a pivot mechanism, and two outmost lower ends of each side strut being connected to the slidable joint on one corresponding pole via another pivot mechanism; the tent frame being characterized in that at least one of the two pivot mechanisms includes:
a first unit including two spaced mounting brackets, which are provided on their facing sides with a pivot hole each; and
a second unit including a main body connected to between the two mounting brackets, two protruded shafts separately protruded from two opposite side surfaces of the main body facing away from each other, and an elastic member connected to the protruded shafts and being capable of providing an elastic force for the two protruded shafts to spring out; the protruded shafts being movably connected to the main body to shift between a compressed position and a sprung-out position; wherein when the protruded shafts are in the compressed position, a smallest distance between two protruded end surfaces of the two protruded shafts is not larger than a distance between the two facing sides of the mounting brackets, and when the protruded shafts are in the sprung-out position, they are protruded from the side surfaces of the main body into the pivot holes on the mounting brackets.
